(19) United States
(12) Patent Application Publication
(10) Pub. No.: US 2022/0191416 A1
(43) Pub. Date: Jun. 16, 2022

(54) PIXEL LEVEL EXPANDABLE MEMORY ARRAY FOR VOLTAGE DOMAIN GLOBAL SHUTTER

(71) Applicant: OMNIVISION TECHNOLOGIES, INC., Santa Clara, CA (US)

(72) Inventor: Boyd Fowler, Sunnyvale, CA (US)

(21) Appl. No.: 17/541,417

(22) Filed: Dec. 3, 2021

Related U.S. Application Data
(60) Provisional application No. 63/125,246, filed on Dec. 14, 2020.

(51) Int. Cl. H04N 5/378; H04N 5/3745; H04N 5/369; H01L 27/146; H01L 27/148

(52) U.S. Cl. CPC H04N 5/378; H04N 5/37452; H01L 27/14831; H04N 5/37455; H01L 27/14612; H04N 5/3698

(57) ABSTRACT

A sample and hold (SH) circuit includes a pixel level connection coupled to a pixel cell. A reset row transistor is coupled between a first supply voltage and the pixel level connection. A source follower row transistor having a gate is coupled to the pixel level connection. A row select row transistor is coupled between the source follower row transistor and a bitline. A first storage transistor is coupled to the pixel level connection. A first storage device is coupled between the first storage transistor and a second supply voltage. A second storage transistor is coupled to the pixel level connection. A second storage device is coupled between the second storage transistor and the second supply voltage.

### CROSS REFERENCE TO RELATED APPLICATION

This application claims the benefit of U.S. Provisional Patent Application No. 63/125,246 filed on Dec. 14, 2020. U.S. Provisional Patent Application No. 63/125,246 is hereby incorporated by reference.

### BACKGROUND INFORMATION

### Field of the Disclosure

This disclosure relates generally to image sensors, and in particular but not exclusively, relates to sample and hold circuitry for use in reading out image data from an image sensor.

### Background

Image sensors have become ubiquitous. They are widely used in digital still cameras, cellular phones, security cameras, as well as medical, automobile, and other applications. The technology used to manufacture image sensors has continued to advance at a great pace. For example, the demands of higher resolution and lower power consumption have encouraged the further miniaturization and integration of these devices.

Image sensors conventionally receive light on an array of pixels, which generates charge in the pixels. The intensity of the light may influence the amount of charge generated in each pixel, with higher intensity generating higher amounts of charge. Correlated double sampling (CDS) is a technique that is used with CMOS image sensors (CIS) to reduce noise from images read out from image sensors by sampling image data from the image sensors and removing undesired offsets sampled from reset value readings from the image sensors. In global shutter CIS design, sample and hold switches are used to sample and hold signal (SHS) readings, as well as sample and hold reset (SHR) readings from the image sensors. The SHR and SHS switches in the sample and hold circuitry are controlled to sample the reset levels and the signal levels from the image sensor respectively. Ideally, during a global sampling phase, all sample and hold switches toggle at the same time to sample the whole frame from the image sensor into storage capacitors. After the global sampling is completed, a row-by-row read out from the image sensor is performed to digitize the sampled reset and signal levels. The digitized difference between the reset and signal levels are used in the CDS calculation to recover the true image signals. To further reduce random noise, correlated multiple sampling (CMS) may be performed.

Implementing CDS reduces the fixed pattern noise (FPN) and other temporal noise, such as kT/C thermal noise, from the image data. Correlated double sampling (CDS) and correlated multiple sampling (CMS) may be done in either analog domain or digital domain.

Voltage domain global shutter (VDGS) pixel array normally uses at least two storage capacitors as memories for the reset voltage value RESET and signal voltage value SIGNAL for CDS, three or more storage capacitors as memories for equal or more than one RESET value and equal or more than one SIGNAL for CMS. To satisfy small kT/C thermal noise requirement, the two storage capacitors need to maintain large enough layout size for a typical capacitance value of 20˜30 pF.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates one example of an imaging system in accordance with the teachings of the present invention.

FIG. 2 shows a schematic of an example of pixel cell and an example sample and hold circuit in an image sensor in accordance with the teachings of the present invention.

FIG. 3 illustrates example timing diagrams of signals found in an example shared pixel cell of a CMOS image sensor during an image data storage and readout in accordance with the teachings of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Examples directed to a sample and hold circuit for use in an image sensor are described herein. In the following description, numerous specific details are set forth to provide a thorough understanding of the examples. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one example” or “one embodiment” means that a particular feature, structure, or characteristic described in connection with the example is included in at least one example of the present invention. Thus, the appearances of the phrases “in one example” or “in one embodiment” in various places throughout this specification are not necessarily all referring to the same example. Furthermore, the particular features, structures, or characteristics may be combined in any suitable manner in one or more examples.

Throughout this specification, several terms of art are used. These terms are to take on their ordinary meaning in the art from which they come, unless specifically defined herein or the context of their use would clearly suggest otherwise. It should be noted that element names and symbols may be used interchangeably through this document (e.g., Si vs. silicon); however, both have identical meaning.

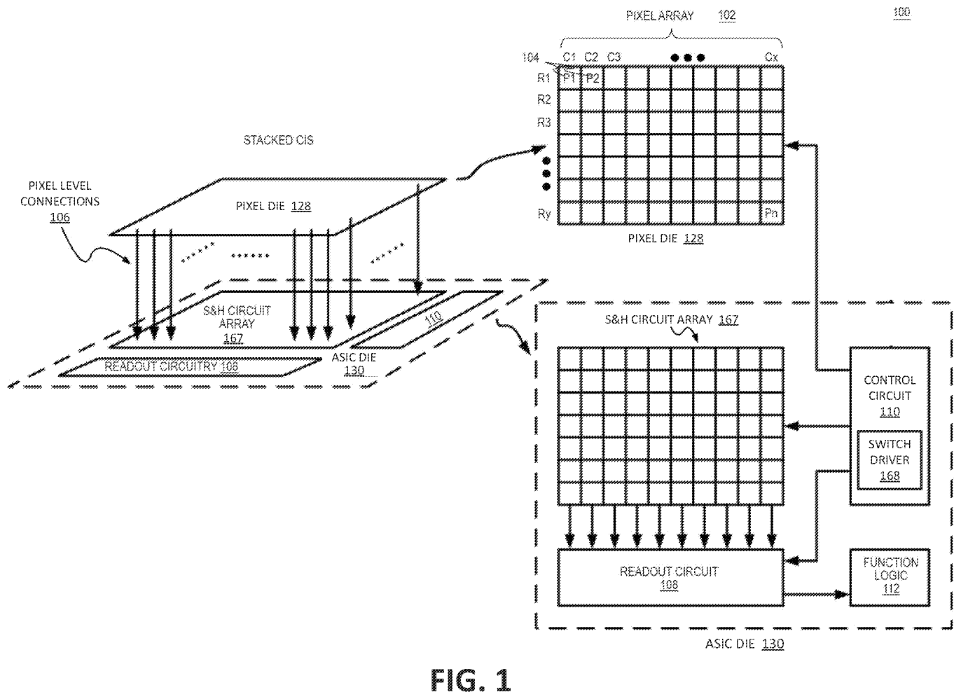

FIG. 1 illustrates one example of an imaging system 100 in accordance with an embodiment of the present disclosure. As shown in the example depicted in FIG. 1, imaging system 100 is implemented as a CMOS image sensor (CIS) in a stacked chipped scheme that includes a pixel die 128 stacked with a logic die or application specific integrated circuit (ASIC) die 130. In the example, the pixel die 128 includes a pixel array 102, and the ASIC die 130 includes an array of sample and hold circuit array 167 that are coupled to the pixel array 102 through pixel level connections 106. ASIC die 130 also includes control circuitry 110, readout circuitry 108, and function logic 112. In one example, pixel array 102 is a two-dimensional (2D) array of photodiodes, or image sensor pixel cells 104 (e.g., pixels P1, P2 Pn). As illustrated, photodiodes are arranged into rows (e.g., rows R1 to Ry) and columns (e.g., column C1 to Cx) to acquire image data of a person, place, object, etc., which can then be used to render a 2D image of the person, place, object, etc. However, photodiodes do not have to be arranged into rows and columns and may take other configurations.

In one example, readout circuitry 108 may be coupled to read out image data from the plurality of photodiodes 104 in pixel array 102 through the sample and hold circuitry 167. As will be described in greater detail below, in one example, the sample and hold circuitry 167 includes a plurality of sample and hold circuits that are coupled to the pixel cells 104 at the pixel level to sample and hold reset values as well as signal values from pixel array 102 through pixel level connections 106. The image data that is readout by readout circuitry 108 may then be transferred to function logic 112. In various examples, readout circuitry 108 may also include amplification circuitry, analog to digital conversion (ADC) circuitry coupled to bitlines, or otherwise.

In one example, function logic 112 may simply store the image data or even manipulate the image data by applying post image effects (e.g., crop, rotate, remove red eye, adjust brightness, adjust contrast, or otherwise). In one example, readout circuitry 108 may readout a row of image data at a time along readout column lines (illustrated) (i.e., bitlines between the sample and hold circuitry 167 and the readout circuit 108) or may readout the image data using a variety of other techniques (not illustrated), such as a serial readout or a full parallel readout of all pixels 104 simultaneously.

In one example, control circuitry 110 is coupled to pixel array 102 to control operation of the plurality of photodiodes in pixel array 102. As will also be described in greater detail below, control circuitry 110 also includes a switch driver 168 that is coupled to generate the control signals to control the sample and hold circuitry 167 to sample and hold the reset voltage values and signal voltage values in the voltage domain (VD) from pixel array 102. In the depicted example, the control circuitry 110 is also coupled to generate a global shutter signal for controlling image acquisition of all pixel values from the pixel array at substantially the same time, which may also be referred to as a voltage domain global shutter (VDGS). In one example, the shutter signal is a global shutter signal for simultaneously enabling all pixel cells 104 within pixel array 102 to simultaneously capture their respective image data during a single acquisition window. In one example, image acquisition is synchronized with lighting effects such as a flash.

In one example, imaging system 100 may be included in a digital camera, cell phone, laptop computer, or the like. Additionally, imaging system 100 may be coupled to other pieces of hardware such as a processor (general purpose or otherwise), memory elements, output (USB port, wireless transmitter, HDMI port, etc.), lighting/flash, electrical input (keyboard, touch display, track pad, mouse, microphone, etc.), and/or display. Other pieces of hardware may deliver instructions to imaging system 100, extract image data from imaging system 100, or manipulate image data supplied by imaging system 100.

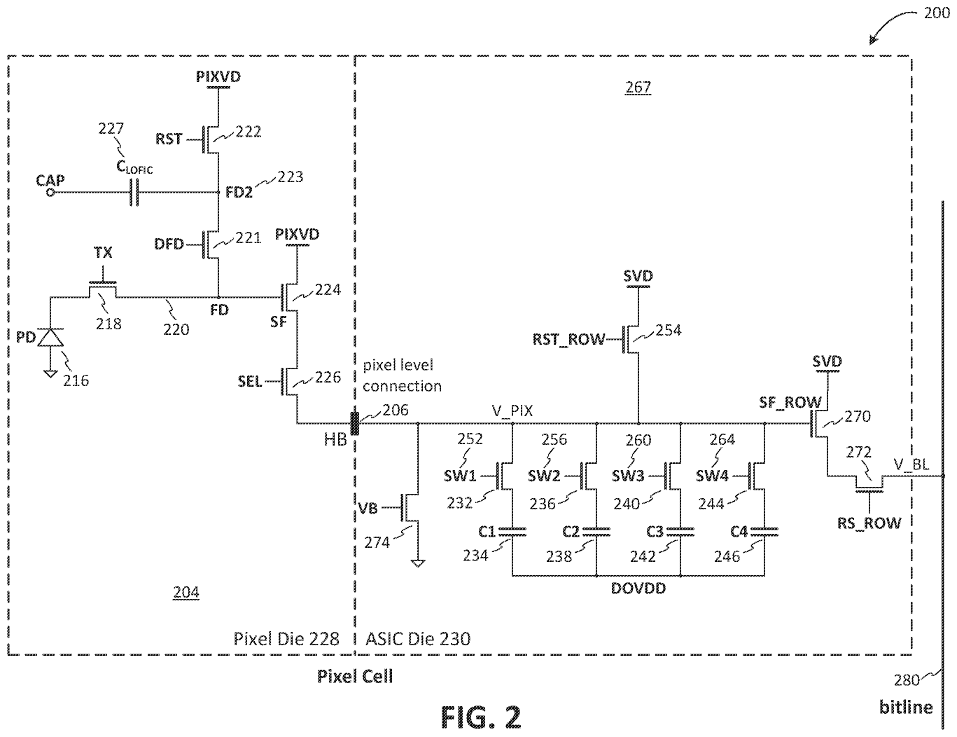

FIG. 2 shows a schematic of an example of pixel cell 200 and an example of sample and hold circuit 267 in an image sensor in accordance with the teachings of the present invention. It is noted that pixel cell 200 and sample and hold circuit 267 of FIG. 2 may be examples of one of the pixel cells 104 and one of the circuits of sample and hold circuit array 167 described in FIG. 1, and that similarly named and numbered elements referenced below are coupled and function similar to as described above. As shown in the depicted example, pixel cell 204 includes a photodiode 216, which is coupled to photogenerate image charge in response to incident light. A transfer transistor 218 is coupled to transfer the photogenerated image charge from the photodiode 216 to a floating diffusion (FD) 220 in response to a transfer signal TX. A dual floating diffusion (DFD) transistor 221 is coupled between the FD 220 and a second floating diffusion (FD2) 223. A reset transistor 222 is coupled to a pixel voltage supply PIXVD to reset the FD2 223 in response to a reset signal RST and further to reset the FD 220 simultaneously in response to a dual floating diffusion signal DFD. In one example, a capacitor C_{LOFIC} 227 is a lateral overflow integration capacitor (LOFIC), which is coupled to receive a CAP signal as shown. C_{LOFIC} 227 is coupled between the FD2 223 and the CAP signal as shown. The gate of a source follower (SF) transistor 224 is coupled to convert the charge in the floating diffusion 220 to an image voltage signal, which is coupled to be output through a select transistor 226 to a pixel level connection 206, such as a hybrid bond (HB), in response to a select signal SEL.

In an imaging system that utilizes CDS, the charge on the floating diffusion 220 is also read out through the pixel level connection 206 after a floating diffusion reset operation, in response to both RST and DFD signals simultaneously, to obtain a reset level, and the charge on the FD 220 is also read out through the pixel level connection 206 after the image charge is transferred to the FD 220 to obtain a signal voltage.

Continuing with the depicted example, the sample and hold circuit 267 includes a first storage transistor 232 that is coupled to the pixel level connection 206 to sample and hold a first reset voltage from pixel cell 204 into a first storage device C1 234 in response to a first reset storage signal SW1 252. In the example, the first storage device C1 234 of the sample and hold circuit 267 is a capacitor. In addition, the sample and hold circuit 267 also includes a second storage transistor 236 that is coupled to the pixel level connection 206 to sample and hold a first signal voltage from pixel cell 204 into a second storage device C2 238 in response to a first signal storage signal SW2 256. In the example, the second storage device C2 238 of the sample and hold circuit 267 is a capacitor. To further the expansion of the storage device to store another pair of reset and signal levels, as in the correlated multiple sampling (CMS) to reduce read noise even more, the sample and hold circuit 267 includes a third storage transistor 240 that is coupled to the pixel level connection 206 to sample and hold a second reset voltage from pixel cell 204 into a third storage device C3 242 in response to a second reset storage signal SW3 260. In the example, the third storage device C3 242 of the sample and hold circuit 267 is a capacitor. In the said expansion above, the sample and hold circuit 267 also includes a fourth storage transistor 244 that is coupled to the pixel level connection 206 to sample and hold a second signal voltage from pixel cell 204 into a fourth storage device C4 246 in response to a second signal storage signal SW4 264. In the example, the fourth storage device C4 246 of the sample and hold circuit 267 is a capacitor.

As will be discussed below, the first reset storage signal SW1 252, the first signal storage signal SW2 256, the second reset storage signal SW3 260 due to the said expansion, and the second signal storage signal SW4 264 due to the said expansion are generated by a sample and hold switch driver circuitry 168 of the control circuitry 110.

A reset row transistor 254 is coupled between a supply voltage SVD and the pixel level connection 206. The reset row transistor 254 is responsive to a reset row signal RST_ROW. In the depicted example, a source follower row transistor 270 having a gate is coupled to the pixel level connection 206. A row select row transistor 272 is coupled between the source follower row transistor 270 and a bitline 280. The row select row transistor 272 is responsive to a row select row signal RS_ROW. In the depicted example, a bias transistor 274 that is biased with a bias voltage VB is coupled between the pixel level connection 206 and ground. The bias transistor 274 serves as a sample and hold (SH) current source. The SH current source provides current to the SF transistor 224 and the pixel level connection 206 with a typical value of ˜20 nA.

In the example, the first terminals of the first, second, third, and fourth storage devices C1 234, C2 238, C3 242, and C4 246 are made of metal-insulator-metal (MiM) capacitors (which have high capacitance per unit area with the lowest parasitics) and are connected to their respective storage transistors 232, 236, 240, and 244, and the second terminals of the first, second, third, and fourth storage devices C1 234, C2 238, C3 242, and C4 246 are connected to a low supply voltage DOVDD. DOVDD is lower in value than SVD. DOVDD may also be connected to ground. To preserve the stored charge values of the first, second, third, and fourth storage devices C1 234, C2 238, C3 242, and C4 246, it is beneficial to reduce static leakage currents of storage transistors 232, 236, 240, and 244 when their respective storage signals SW1 252, SW2 256, SW3 260, and SW4 264 are low. In one example, the values of supply voltages DOVDD and SVD may be tuned to minimize the static leakage currents of storage transistors 232, 236, 240, and 244. The static leakage currents may increase when the length (L) of the storage transistor decreases. The L will get shorter while the size of the storage transistor further shrinks.

In other examples, branches that include each of the storage devices C1-C4 and their respectively coupled storage transistors may also be expanded to a plurality of j branches, where j=5, 6, . . . , 16. The jth branch consists of a respective storage device Cj and its coupled corresponding storage transistor. The plurality of j branches may serve the purpose of CMS.

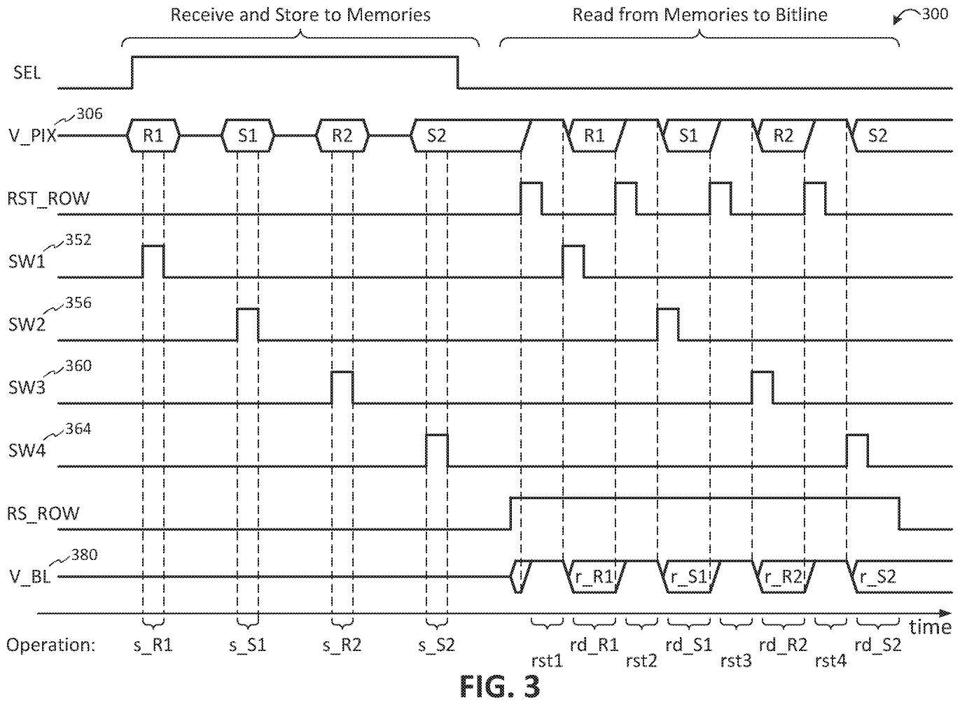

FIG. 3 illustrates example timing diagrams 300 of signals found in an example shared pixel cell of a CMOS image sensor during an image data storage and readout in accordance with the teachings of the present disclosure. It is appreciated that the signals illustrated in FIG. 3 may be examples of the signals found in the example pixel cell 204 of FIG. 2 above, and that similarly named and numbered elements described above are coupled and function similarly below.

As will be described in the example readouts depicted in FIG. 3, correlated double sampling (CDS) is performed in the readouts of the photodiode (PD) and/or the lateral overflow integration capacitor (LOFIC). As such, a reset image charge value as well as a signal image charge value will be read out from the PD and/or the LOFIC. Normalized image charge values can be determined in response to the differences between the signal image charge values and the reset image charge values. As a result, a total of four analog to digital (AD) operations are performed on the image charge values that are read out from the PD and/or the LOFIC, as will be indicated with the four AD operations associated with r_R1, r_S1, r_R2, and r_S2 occurring in the V_BL 380 timelines in FIG. 3.

Beginning specifically with the example depicted in FIG. 3, the select signal SEL is initially set to a low value. The select signal SEL then transitions to a high value, which turns on the select transistor 226 coupling the pixel cell 204 to the pixel level connection 206 and enabling the PD and/or LOFIC to be read out from the pixel cell 204.

Next, the reset signal RST and the DFD signal are both pulsed simultaneously (not shown), which pulse the reset transistor 222 and the DFD transistor 221, and resets the pixel cell 204. The first reset level of the pixel cell 204 that appears on the pixel level connection 206 or V_PIX 306 is R1.

The first reset storage signal SW1 352 is pulsed as shown, which pulses the first storage transistor 232 in the sample and hold circuit 267, and therefore stores the first reset image charge value of the PD 216 (and/or LOFIC) into the first storage device C1 234, which is indicated in FIG. 3 as operation s_R1 (store R1).

Next, the signal TX is pulsed (not shown), which pulses the transfer transistor 218 in pixel cell 204, which transfers the image charge from the PD 216 to the floating diffusion FD 220. This image charge is amplified by the SF transistor 224 and appears on V_PIX 306 as the first image level S1 of the pixel cell 204.

The first signal storage signal SW2 356 is pulsed as shown, which pulses the second storage transistor 236 in the sample and hold circuit 267, and therefore stores the first signal image charge value of the PD 216 (and/or LOFIC) into the second storage device C2 238, which is indicated in FIG. 3 as operation s_S1 (store S1).

In a case where correlated multiple sampling (CMS) is performed, the additional reset and signal levels are generated and stored. Thus, in the depicted example, the reset signal RST and the DFD signal are both pulsed simultaneously (not shown) again, which pulses the reset transistor 222 and the DFD transistor 221, and resets the pixel cell 204. A second reset level of the pixel cell 204 appears on V_PIX 306 as R2.

The second reset storage signal SW3 360 is pulsed as shown, which pulses the third storage transistor 240 in the sample and hold circuit 267, and therefore stores the second reset image charge value of the PD 216 (and/or LOFIC) into the third storage device C3 242, which is indicated in FIG. 3 as operation s_R2 (store R2).

Again next, the signal TX is pulsed (not shown), which pulses the transfer transistor 218 in pixel cell 204, which transfers the image charge from the PD 216 to the floating diffusion FD 220. This image charge is amplified by the SF transistor 224 and appears on V_PIX 306 as a second image level S2 of the pixel cell 204.

The second signal storage signal SW4 364 is pulsed as shown, which pulses the fourth storage transistor 244 in the sample and hold circuit 267, and therefore stores the second signal image charge value of the PD 216 (and/or LOFIC) into the fourth storage device C4 246, which is indicated in FIG. 3 as operation s_S2 (store S2).

When it comes time to read stored image data from the memories (storage devices), the row select row signal RS_ROW is transitions to a high value to turn on the row select row transistor 272. Thereafter, the reset row signal RST_ROW is pulsed, which resets the sample and hold circuit 367 as indicated in FIG. 3 as operation rst1, and then the first reset storage signal SW1 352 is pulsed as shown in FIG. 3, which couples the first reset image charge value of the PD previously stored in the first storage device C1 234 to V_PIX 306 as R1, and further to the bitline 280 (V_BL 380) as V_BL=r_R1. This readout operation is indicated in FIG. 3 as operation rd_R1 . A first ADC conversion can take place during the rd R1 period by an ADC coupled to the bitlines 280 in readout circuitry 108 to convert the first reset analog voltage r_R1 to a digital value and to store the first reset digital value of image data in function logic 112.

After the first ADC conversion above on the previously stored first reset image charge value R1 of the PD stored in storage device C1 234 is complete, the reset row signal RST_ROW is pulsed, which resets the sample and hold circuit 367 as indicated in FIG. 3 as operation rst2, and then the first signal storage signal SW2 356 is pulsed, which couples the first signal image charge value of the PD previously stored in the second storage device C2 238 to V_PIX 306 as S1, and further to the bitline 280 as V_BL=r_S1. This readout operation is indicated in FIG. 3 as operation rd_S1. A second ADC conversion can take place during the rd_S1 period by ADC in readout circuitry 108 to convert the first signal analog voltage r_S1 to a digital signal and to store the first signal digital value of image data in function logic 112.

Once both ADC operations have been conducted, for a pair of signals, the two digital values of the first reset analog voltage r_R1 and the first signal analog voltage r_S1 may be subtracted from each other, normally done in function logic 112, to recover a true image signal based on the CDS calculation.

Subsequently, to further read stored image data from the memories, the row select row signal RS_ROW remains high value and the row select row transistor 272 remains on. The reset row signal RST_ROW is pulsed, which resets the sample and hold circuit 367 again as indicated in FIG. 3 as operation rst3, and then the second reset storage signal SW3 360 is pulsed as shown in FIG. 3, which couples the second reset image charge value of the PD previously stored in the third storage device C3 242 to V_PIX 306 as R2, and further to the bitline 280 as V_BL=r_R2. This readout operation is indicated in FIG. 3 as operation rd_R2. A third ADC conversion can take place during the rd_R2 period by ADC in readout circuitry 108 to convert the second reset analog voltage r_R2 to a digital value and to store the second reset digital value in function logic 112.

After the third ADC conversion above on the previously stored second reset image charge value of the PD stored in storage device C3 242 is complete, the reset row signal RST_ROW is pulsed, which repeatedly resets the sample and hold circuit 367 as indicated in FIG. 3 as operation rst4, and then the second signal storage signal SW4 364 is pulsed, which couples the second signal image charge value of the PD previously stored in the fourth storage device C4 246 to V_PIX 306 as S2, and further to the bitline 280 as V_BL=r_S2. This readout operation is indicated in FIG. 3 as operation rd_S2. A fourth ADC conversion can take place during the rd_S2 period by ADC in readout circuitry 108 to convert the second signal analog voltage S2 to a digital signal and to store the second signal digital value of the image data in function logic 112.

Once both ADC operations have been conducted, for a second pair of signals, the two digital values of the second reset analog voltage r_R2 and the second signal analog voltage S2 may be subtracted from each other in digital domain, normally in function logic 112, to recover another true image signal based on the CDS calculation.

Given the four digital values of the first reset analog voltage R1, the second reset analog voltage R2, the first signal analog voltage S1 and the second signal analog voltage S2 achieved above, if both S1 and S2 are taken from two exposures of the same object sequentially as shown in FIG. 3, a CMS measurement can be conducted to reduce the random noise by a factor of square root of 2 when (R1+R2)/2 is subtracted from (S1+S2)/2 to recover the true image signal.

With further added pair of Ri/Si, where i=3, 4, . . . , 8, for N pairs of Ri/Si to be used, CMS measurement can be achieved with:

$$Image Value = \frac{1}{N} {\sum }_{i = 1}^{N} ( S i - R i ) \qquad ( 1 )$$

And random noise of image:

$$Image Noise = \frac{NOISE\_defaut}{\sqrt{N}} \qquad ( 2 )$$

Equations (1) and (2) are characteristics of CMS that shows a clear benefit in reducing random noise.

As shown in FIG. 3, the sample and hold circuit 267 may serve as additional charge storage. The storage deals with charge overflow at different level from that of the C_{LOFIC} 227. The two different storage levels are separated by the source follower 224.

Also as shown in FIG. 3, a storage-transistor-device pair (or branch) configured of the storage transistor and the storage device in series forms a fundamental memory unit. Such a fundamental memory unit makes the memory highly expandable based on any existing memory array in the sample and hold circuit 267 when needed. Such an expansion may be based on increased requirement on signal to noise ratio (SNR), which cuts fixed pattern noise (FPN) as result, or other design requirements. The minimized number of transistors 252, 254, 256, 260, 264, 270, and 274 shared on the pixel level connection 206 forms the smallest and simplest circuit to construct while maintaining good performance without introducing any additional disparages. The minimized number of transistors shared on the pixel level connection 206 may also minimize attenuation to signal charges which may normally be femto-to-nano-Coulomb-sized short pulse signals.

High dynamic range and/or range differentiation like motion detections may benefit from the use of the disclosed highly expandable memory unit.

The above description of illustrated examples of the invention is not intended to be exhaustive or to limit the invention to the precise forms disclosed. While specific examples of the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific examples disclosed in the specification. Rather, the scope of the invention is to be determined entirely by the following claims, which are to be construed in accordance with established doctrines of claim interpretation.

What is claimed is:

1. A sample and hold (SH) circuit for use in an image sensor, comprising:
a pixel level connection coupled to a pixel cell;
a reset row transistor coupled between a first supply voltage and the pixel level connection;
a source follower row transistor having a gate coupled to the pixel level connection;
a row select row transistor coupled between the source follower row transistor and a bitline;
a first storage transistor coupled to the pixel level connection;
a first storage device coupled between the first storage transistor and a second supply voltage;
a second storage transistor coupled to the pixel level connection; and
a second storage device coupled between the second storage transistor and the second supply voltage.

2. The SH circuit of claim 1, further comprises:
a third storage transistor coupled to the pixel level connection;
a third storage device coupled between the third storage transistor and the second supply voltage;
a fourth storage transistor coupled to the pixel level connection; and
a fourth storage device coupled between the fourth storage transistor and the second supply voltage, wherein the first storage device, the second storage device, the third storage device, and the fourth storage device are made of metal-insulator-metal (MiM) capacitors.

3. The SH circuit of claim 2, further comprises N times more additional storage-transistor-device pair(s), wherein N is an integer between 1 and 6, and wherein each storage-transistor-device pair comprises:
a pair storage transistor coupled to the pixel level connection, and;
a pair storage device coupled between the pair storage transistor and the second supply voltage, wherein the pair storage device is made of metal-insulator-metal (MiM) capacitor.

4. The SH circuit of claim 1, further comprises a sample and hold current source coupled between the pixel level connection and a ground.

5. The SH circuit of claim 1, wherein the SH circuit is configured to sample and hold a reset image charge value from the pixel level connection to the first storage device and then sample and hold a signal image charge value from the pixel level connection to the second storage device during a receiving and storing period.

6. The SH circuit of claim 1, wherein the SH circuit is configured to perform a readout operation on the reset image charge value stored in the first storage device and then perform a readout operation on the signal image charge value stored in the second storage device during a readout to the bitline period.

7. The SH circuit of claim 1, wherein the first supply voltage is higher than the second supply voltage.

8. The SH circuit of claim 1, wherein the first supply voltage and the second supply voltage are adjustable voltages, wherein final adjusted values of the first supply voltage and the second supply voltage are to minimize leakage currents through the first storage transistor and the second storage transistor when both the first storage transistor and the second storage transistor are in switched off states in response to a switch-off voltage applied to their gates.

9. The SH circuit of claim 1, wherein the second supply voltage is connected to a zero voltage.

10. An imaging system, comprising:
a pixel array including a plurality of pixel cells arranged in rows and columns, wherein each of the pixel cells is coupled to generate image charge in response to incident light;
a control circuitry coupled to the pixel array to control operation of the pixel array; and
a readout circuit coupled to the pixel array to read out the image charge from the pixel array, wherein the readout circuit comprises:
a sample and hold (SH) circuit coupled between a pixel level connection coupled to a pixel cell of a plurality of pixel cells of the pixel array and a bitline of a plurality of bitlines of the readout circuit; and
an analog to digital converter (ADC) coupled to the bitline.

11. The imaging system of claim 10, further comprising function logic coupled to the readout circuit to store and to process digital representations of the image charge values from the pixel array.

12. The imaging system of claim 10, wherein each of the SH circuits comprises:
the pixel level connection coupled to the pixel cell;
a reset row transistor coupled between a first supply voltage and the pixel level connection;
a source follower row transistor having a gate coupled to the pixel level connection;
a row select row transistor coupled between the source follower row transistor and a bitline;
a first storage transistor coupled to the pixel level connection;
a first storage device coupled between the first storage transistor and a second supply voltage;
a second storage transistor coupled to the pixel level connection; and
a second storage device coupled between the second storage transistor and the second supply voltage.

13. The imaging system of claim 12, wherein each of the SH circuits further comprises:
a third storage transistor coupled to the pixel level connection;
a third storage device coupled between the third storage transistor and the second supply voltage;
a fourth storage transistor coupled to the pixel level connection; and
a fourth storage device coupled between the fourth storage transistor and the second supply voltage, wherein the first storage device, the second storage device, the third storage device, and the fourth storage device are made of metal-insulator-metal (MiM) capacitors.

14. The imaging system of claim 13, wherein each of the SH circuits further comprises N times more additional storage-transistor-device pair(s), wherein N is an integer between 1 and 6, and wherein each storage-transistor-device pair comprises:
a pair storage transistor coupled to the pixel level connection, and;
a pair storage device coupled between the pair storage transistor and the second supply voltage, wherein the pair storage device is made of metal-insulator-metal (MiM) capacitor.

15. The imaging system of claim 12, wherein each of the SH circuits further comprises a sample and hold current source coupled between the pixel level connection and a ground.

16. The imaging system of claim 12, wherein each of the SH circuits is configured to sample and hold a reset image charge value from the pixel level connection to the first storage device and then sample and hold a signal image charge value from the pixel level connection to the second storage device during a receiving and storing period.

17. The imaging system of claim 12, wherein each of the SH circuits is configured to perform a readout operation on the reset image charge value stored in the first storage device and then perform a readout operation on the signal image charge value stored in the second storage device during a readout to the bitline period.

18. The imaging system of claim 12, wherein the first supply voltage is higher than the second supply voltage.

19. The imaging system of claim 12, wherein the first supply voltage and the second supply voltage are adjustable voltages, wherein final adjusted values of the first supply voltage and the second supply voltage are to minimize leakage currents through the first storage transistor and the second storage transistor when both the first storage transistor and the second storage transistor are in switched off states in response to a switch-off voltage applied to their gates.

20. The imaging system claim 12, wherein the second supply voltage is connected to a zero voltage.

21. The imaging system of claim 10, wherein each of the pixel cells comprises:
a photodiode coupled to photogenerate the image charge in response to incident light;
a floating diffusion coupled to receive the image charge from the photodiode;
a transfer transistor coupled between the photodiode and the floating diffusion to transfer the image charge from the photodiode to the floating diffusion;
a dual floating diffusion (DFD) transistor coupled between a second floating diffusion and the floating diffusion; and
a lateral overflow integration capacitor (LOFIC) coupled between a CAP signal and the second floating diffusion.

22. The imaging system of claim 21, wherein each of the pixel cells further comprises:
a source follower transistor coupled to a supply voltage and having a gate coupled to the floating diffusion; and
a select transistor coupled between the source follower transistor and the pixel level connection, wherein the source follower transistor is coupled to output the image charge value to the pixel level connection in response to the image charge in the floating diffusion, wherein a hybrid bond is coupled between the select transistor and the SH circuit.

23. The imaging system of claim 21, wherein each of the pixel cells further comprises a reset transistor coupled between the supply voltage and the second floating diffusion.

24. The imaging system of claim 10, wherein the pixel array is placed in a pixel die and the readout circuit, the control circuitry and a plurality of SH circuits are placed in an ASIC die.

25. The imaging system of claim 10, wherein the SH circuit is controlled by a switch driver of the control circuitry, wherein the control circuitry generates a global shutter signal for controlling image acquisition of all pixel values from the pixel array at substantially the same time.
